(19) United States
(12) Patent Application Publication
(10) Pub. No.: US 2003/0234356 A1
(43) Pub. Date: Dec. 25, 2003

(54) Method and apparatus for the detection of noncovalent interactions by mass spectrometry-based diffusion measurements

(76) Inventors: Lars Konermann, London (CA); Sonya M. Clark, London (CA)

Correspondence Address: DOWELL & DOWELL PC, SUITE 309, 1215 JEFFERSON DAVIS HIGHWAY, ARLINGTON, VA, 22202

(21) Appl. No.: 10/448,315

(22) Filed: May 30, 2003

(30) Foreign Application Priority Data
May 31, 2002 (CA) 2,387,316

(51) Int. Cl. H01J 49/00

(52) U.S. Cl. 250/281

(57) ABSTRACT

The present invention provides a method and apparatus for detecting the noncovalent binding of a potential ligand (such as a drug candidate) to a target, e.g. a biochemical macromolecule such as a protein. The method is based on the Taylor dispersion of an initially sharp boundary between a carrier solution, and an analyte solution that contains the potential ligand(s) and the target. Dispersion profiles of one or more potential ligands are monitored by mass spectrometry at the exit of the laminar flow tube. Potential ligands will usually be relatively small molecules that have large diffusion coefficients. In the absence of any noncovalent interactions in solution, very steep dispersion profiles are expected for these potential ligands. However, a ligand that binds to a large target in solution, will show an apparent diffusion coefficient that is significantly reduced, thus resulting in a more extended dispersion profile. Noncovalent binding can therefore be detected by monitoring dispersion profiles of potential ligands in the presence and in the absence of the target. In contrast to other mass spectrometry-based methods for detecting noncovalent interactions, this method does not rely on the preservation of specific noncovalent interactions in the gas phase. This method has an excellent sensitivity and selectivity, therefore it can be used for testing multiple potential ligands simultaneously. The method is therefore useful for the high throughput screening of compound libraries.

### CROSS REFERENCE TO RELATED FOREIGN PATENT APPLICATION

This application claims the benefit of priority from Canadian patent application Serial No. 2,387,316 filed on May 31, 2002, entitled METHOD AND APPARATUS FOR THE DETECTION OF NONCOVALENT INTERACTIONS BY MASS SPECTROMETRY-BASED DIFFUSION MEASUREMENTS, which was filed in English.

### FIELD OF INVENTION

The present invention provides a method and apparatus for the detection of noncovalent interactions between analyte species in the liquid phase by mass spectrometry-based diffusion measurements, and more particularly the present invention relates to a method and apparatus using electrospray ionization (ESI) or atmospheric pressure chemical ionization (APCI) mass spectrometry (MS) for the detection of noncovalent interactions.

### BACKGROUND OF THE INVENTION

Noncovalent interactions play a central role for numerous physiological processes. Of particular importance is the noncovalent binding of small molecules to biological macromolecules such as proteins or nucleic acids. One example is the binding of an inhibitor to an enzyme; thus providing the possibility of regulating the enzyme activity by changing the concentration of the inhibitor. Another example is the binding of a hormone to a hormone receptor, which can have profound effects on various processes in a living organism. Many drugs act by noncovalently binding to a protein or other macromolecular target, often mimicking structural features of a naturally occurring ligand. The detection of noncovalent interactions is therefore an important initial step in the development of new drugs.

Advances in combinatorial chemistry leading to the synthesis of chemical compound libraries, combined with considerable progress in the areas of genomics and proteomics, have provided increased opportunities for discovering and developing new drugs. However, these advances pose challenges of scale in terms of identifying fruitful combinations of molecules. High throughput screening (HTS) is a process in which members of chemical compound libraries are tested for binding to target macromolecules. Molecules that successfully bind to the macromolecular target are identified as “hits” and thus pass the first milestone on their way to becoming drugs. HTS addresses the need to assay a large number of molecules within a relatively short time frame. However, there remains a need in the art to increase the accuracy of HTS techniques to reliably identify noncovalent interactions. Strategies of this kind will increase the opportunity at the outset of the drug discovery and development process to identify novel compounds that may subsequently be chemically modified to optimize their activity.

A number of methods are available for the detection of noncovalent interactions, some of which are suitable for HTS applications. These different techniques include affinity chromatography (Fassina, Encyclopedia of Life Sciences (www.els.net); Nature Publishing Group: London, 2001), surface plasmon resonance (SPR)-based binding assays (Myszka & Rich, Pharm Sci. Tech. Today 3, 310 (2000)), fluorescence correlation spectroscopy (Rigler, J. Biotech. 41, 177 (1995)), and several nuclear magnetic resonance (NMR) spectroscopy techniques (Hajduk, Q. Rev. Biophys. 32, 211 (1999)). All of these methods suffer from certain limitations. NMR requires relatively high analyte concentrations, typically in the millimolar range, where nonspecific complexation may occur. Also, it is often difficult to identify unique resonances for compounds that have similar chemical structures. Fluorescence-based approaches are far more sensitive than NMR, but they require the availability of fluorescently labeled compounds. Affinity chromatography and SPR are relatively time-consuming because they require the chemical immobilization of compounds.

United States Patent Publication US20020134718A1 entitled Apparatus for screening compound libraries; United States Patent Publication US 20020001815A1 entitled Methods for screening compound libraries; U.S. Pat. No. 6,395,169 entitled Apparatus for screening compound libraries; U.S. Pat. No. 6,387,257 entitled Apparatus for screening compound libraries; U.S. Pat. No. 6,355,163 entitled Apparatus for screening compound libraries; United States Patent Publication US20010003328A1 entitled Apparatus for screening compound libraries; and U.S. Pat. No. 6,054,047 entitled Apparatus for screening compound libraries all disclose devices and methods that use affinity chromatography in combination with MS to identify and rank members of a compound library that bind to a target receptor.

A different approach is proposed in U.S. Pat. No. 6,432,651, which discloses a method to detect and analyze tight-binding ligands in complex biological samples which combines a capillary electrophoresis (CE) technique for screening complex biological samples with MS, to provide a procedure for identifying and characterizing candidate ligands that bind at or above a selected binding strength to a selected target molecule.

U.S. Pat. No. 6,054,709 discloses a method and apparatus for determining rates and mechanisms of reactions in solution with the apparatus including a capillary tube and mass spectrometer.

A relatively new approach which has potential HTS applications is the use of ESI-MS for the direct observation of noncovalent complexes (Loo, Int. J. Mass Spectrom. 200, 175 (2000)). During ESI, intact gas phase ions are generated from analyte molecules in solution. These ions can be separated and analyzed according to their mass-to-charge ratio in a mass spectrometer. Due to the “softness” of the ESI process, this method often allows the observation of noncovalent ligand-macromolecule interactions by directly observing the corresponding gas phase complexes in the mass spectrum (Jorgensen, Anal. Chem. 70, 4427 (1998)). The excellent sensitivity and selectivity of modern ESI mass spectrometers make this approach very attractive for many applications, especially in cases where the constituents of the noncovalent complex are only available in small quantities. Unfortunately, numerous noncovalent complexes do not remain intact during the ESI process. This is thought to be the case primarily for complexes that are stabilized by hydrophobic interactions (Robinson, J. Am. Chem. Soc. 118, 8646 (1996)). However, even in the case of ionic interactions, the relative abundance of complex ions often does not match that expected based on the solution equilibrium (Mauk, J. Am. Soc. Mass Spectrom. 13, 59 (2002)). Because of these possible “false negative” results, the absence of a noncovalent complex in an ESI mass spectrum does not rule out that the complex exists in solution. ESI-MS can also result in “false positive” results, as certain ions tend to cluster together during ESI, although the corresponding complex does not exist in solution (Juraschek, J. Am. Soc. Mass Spectrom. 10, 300 (1999); Zechel, Biochemistry 37, 7664 (1998)). EP1106702A1 discloses high-throughput screening of compounds using electrospray ionization mass spectrometry (ESI-MS). In addition, U.S. Pat. No. 6,428,956 entitled Mass spectrometric methods for biomolecular screening; US20020102572A1 entitled Mass spectrometric methods for biomolecular screening; U.S. Pat. No. 6,329,146 entitled Mass spectrometric methods for biomolecular screening; and WO0158573A1 entitled Optimization of ligand affinity for RNA targets using mass spectrometry disclose methods for determining the relative affinity of a ligand for a biomolecular target using competitive binding and electrospray mass spectrometry.

It would be desirable to provide a method for the detection of noncovalent interactions using mass spectrometry that avoids the aforementioned limitations and permits screening of large numbers of potential ligands, e.g. combinatorial libraries, on a rapid time scale (HTS), and does not rely on the structural integrity of noncovalent complexes in the gas phase.

### SUMMARY OF INVENTION

The present invention discloses a method using electrospray ionization mass spectrometry (ESI-MS) for the detection of noncovalent interactions that does not rely on the structural integrity of noncovalent complexes in the gas phase. Instead, noncovalent complexes are identified by studying the diffusion behavior of their constituents in solution. There is first disclosed the theoretical background of this invention, followed by examples that demonstrate the viability of the invention for detecting ligand-protein noncovalent interactions. Alternatively, atmospheric pressure chemical ionization mass spectrometry (APCI-MS) may be used. The method and apparatus of this invention can reveal noncovalent interactions between ligands and targets that go undetected in conventional ESI-MS experiments.

In one aspect of the present invention there is provided a method of measuring diffusion coefficients of chemical or biochemical analyte species in solution, comprising the steps of:

a) injecting an analyte solution containing a chemical or biochemical analyte species into a first end of a laminar flow tube of selected length and flowing the analyte solution to a second end of the laminar flow tube;

b) converting said analyte solution exiting said laminar flow tube at the second end thereof to a gaseous spray of ions and transferring the ions within said gaseous spray into a mass spectrometer; and

c) developing a dispersion profile of the chemical or biochemical analyte species by monitoring signal intensities, measured by the mass spectrometer, of ions of the chemical or biochemical analyte species as a function of time, and determining an apparent diffusion coefficient of the chemical or biochemical analyte species in the laminar flow tube from the signal intensity versus time dispersion profile.

In another aspect of the invention there is provided a method for detecting noncovalent binding of a potential ligand to one or more targets, comprising:

a) injecting a first analyte solution containing one or more potential ligands to one or more targets into a first end of a laminar flow tube of selected length and flowing the first analyte solution to a second end of the laminar flow tube;

b) converting said first analyte solution exiting said laminar flow tube at the second end thereof to a gaseous spray of ions and transferring the ions within said gaseous spray into a mass spectrometer;

c) developing dispersion profiles of the one or more potential ligands by monitoring signal intensities, measured by the mass spectrometer, of ions of the one or more potential ligands as a function of time;

d) injecting a second analyte solution containing said one or more potential ligands and the one or more targets into the first end of the laminar flow tube and flowing the second analyte solution to the second end of the laminar flow tube;

e) converting said second analyte solution exiting said laminar flow tube at the second end thereof to a gaseous spray of ions and transferring the ions within said gaseous spray into the mass spectrometer after disrupting noncovalently bound complexes formed between the one or more potential ligands and the one or more targets;

f) developing dispersion profiles of the one or more potential ligands in the presence of the one or more targets by monitoring signal intensities, measured by the mass spectrometer, of ions produced in step e) of the one or more potential ligands as a function of time; and

g) detecting noncovalent binding between the one or more potential ligands and the one or more targets by comparing the dispersion profiles developed in step f) to the dispersion profiles developed in step c), wherein a noticeable change in dispersion profile of any of the one or more potential ligands is indicative of formation of a noncovalent complex between that potential ligand and one or more of the targets.

The present invention also provides a method for detecting noncovalent binding of a potential ligand to a target, comprising:

a) injecting a first analyte solution containing one or more potential ligands to a target into a first end of a laminar flow tube of selected length and flowing the first analyte solution to a second end of the laminar flow tube;

b) converting said first analyte solution exiting said laminar flow tube at the second end thereof to a gaseous spray of ions and transferring the ions within said gaseous spray into a mass spectrometer;

c) developing dispersion profiles of the one or more potential ligands by monitoring signal intensities, measured by the mass spectrometer, of ions of the one or more potential ligands as a function of time;

d) injecting a second analyte solution containing said one or more potential ligands and the target into the first end of the laminar flow tube and flowing the second analyte solution to the second end of the laminar flow tube;

e) converting said second analyte solution exiting said laminar flow tube at the second end thereof to a gaseous spray of ions and transferring the ions within said gaseous spray into the mass spectrometer after disrupting noncovalently bound complexes formed between the one or more potential ligands and the target;

f) developing dispersion profiles of the one or more potential ligands in the presence of the target by monitoring signal intensities, measured by the mass spectrometer, of ions produced in step e) of the one or more potential ligands as a function of time; and

g) detecting noncovalent binding between the one or more potential ligands and the target by comparing the dispersion profiles developed in step f) of potential ligands in the presence of the target to the dispersion profiles developed in step c) of the potential ligands in the absence of the target wherein a noticeable change in dispersion profile of any of the one or more potential ligands is indicative of formation of a noncovalent complex between that potential ligand and the target.

The present invention also provides a A method for detecting noncovalent binding of a potential ligand to one or more targets, comprising the steps of:

a) determining a dispersion profile under laminar flow conditions for each of one or more potential ligands in an analyte solution;

b) injecting an analyte solution containing said one or more potential ligands and one or more targets into the first end of the laminar flow tube and flowing the analyte solution to the second end of the laminar flow tube;

c) converting said analyte solution exiting said laminar flow tube at the second end thereof to a gaseous spray of ions and transferring the ions within said gaseous spray into the mass spectrometer after disrupting noncovalently bound complexes formed between the one or more potential ligands and the one or more targets;

d) developing dispersion profiles of the one or more potential ligands in the presence of the one or more targets by monitoring signal intensities, measured by the mass spectrometer, of ions produced in step c) of the one or more potential ligands as a function of time; and

e) detecting noncovalent binding between the one or more potential ligands and the one or more targets by comparing the dispersion profiles developed in step d) of potential ligands in the presence of the one or more targets to known dispersion profiles for said one or more potential ligands in the absence of the one or more targets wherein a noticeable change in dispersion profile of any of the one or more potential ligands is indicative of formation of a noncovalent complex between that potential ligand and one or more of the targets.

In another aspect of the invention there is provided a method for detecting noncovalent binding between a target and one or more potential ligands, comprising:

a) injecting a first analyte solution containing a test ligand and a target known to bind with said test ligand into a first end of a laminar flow tube of selected length and flowing the analyte solution to a second end of the laminar flow tube;

b) converting said first analyte solution exiting said laminar flow tube at the second end thereof to a gaseous spray of ions and transferring the ions within said gaseous spray into the mass spectrometer after disrupting noncovalently bound complexes formed between the test ligand and the target;

c) developing a first dispersion profile of the test ligand by monitoring signal intensities, measured by the mass spectrometer, of ions of the test ligand as a function of time;

d) injecting a second analyte solution containing said target and said test ligand and one or more potential ligands in addition to the test ligand into the first end of the laminar flow tube and flowing the analyte solution to the second end of the laminar flow tube;

e) converting said second analyte solution exiting said laminar flow tube at the second end thereof to a gaseous spray of ions and transferring the ions within said gaseous spray into the mass spectrometer after disrupting noncovalently bound complexes formed between the target and any of said test ligand and one or more ligands in addition to the test ligand;

f) developing a second dispersion profile of the test ligand by monitoring signal intensities, measured by the mass spectrometer, of ions of the test ligand as a function of time; and

g) comparing said first and second dispersion profiles wherein a noticeable difference between the first and second dispersion profiles of the test ligand is indicative of formation of a noncovalent complex between the target and said one or more potential ligands.

In another aspect of the present invention there is provided an apparatus for measuring dispersion profiles of one or more chemical or biochemical analyte species in solution, comprising:

a) a mass spectrometer having an inlet;

b) a laminar flow system including

a laminar flow tube of selected length having an inlet and an outlet, the outlet being in flow communication with the inlet of said spectrometer, and the inlet of the laminar flow tube being in flow communication with a source of the analyte liquid mixture or a source of a carrier solution,

a valve mechanism connected to the inlet of the laminar flow system for controlling liquid flow from the source of the analyte liquid mixture or the source of the carrier solution, the valve mechanism having a structure that facilitates the creation of a sharp liquid boundary between analyte liquid mixture at the inlet of the laminar flow tube and carrier solution located downstream of the inlet in the laminar flow tube prior to pumping the analyte liquid mixture through the laminar flow tube,

a pump for pumping liquid through the laminar flow tube; and

c) the mass spectrometer being configured so that when liquid is pumped through the laminar flow tube dispersion profiles of the one or more chemical or biochemical analyte species present in the analyte liquid mixture are developed by monitoring signal intensities, measured by the mass spectrometer, of one or more ions of the one or more potential ligands as a function of time.

### BRIEF DESCRIPTION OF DRAWINGS

The following is a description, by way of example only, of the method and apparatus for the detection of noncovalent interactions by mass spectrometry-based diffusion measurements, reference being made to the drawings, in which:

FIG. 1 shows dispersion profiles calculated from Equation 17 for D=1×10⁻¹⁰ m²/s (dashed line), and for D=10×10⁻¹⁰ m²/s (solid line). The following parameters were used: flow tube radius R=129.1 μm, tube length l=3.013 m, flow rate=10 μL/min, average flow velocity \overline{v}=3.183×10⁻³ m/s. The tendency of radial diffusion to counteract the dispersion of the analyte front by the laminar flow profile is clearly evident.

FIG. 2 shows a schematic setup for Taylor dispersion measurements by ESI-MS. S1, syringe containing analyte solution; S2, syringe containing a “make-up” solvent, such as a methanol/acetic acid mixture. S1 and S2 are driven by stepper motors. SBM, sliding block mechanism; ILT, inlet tube; LFT, laminar flow tube; M, mixer; ESI-MS, electrospray mass spectrometer. Arrows indicate the direction of liquid flow.

FIG. 3 shows a schematic representation of dispersion profiles expected for a potential ligand (assumed to be a small molecule, solid line) and for a macromolecular target (dotted line). (A) Ligand in the presence of the target, no noncovalent binding; (B) ligand noncovalently bound to the target.

FIG. 4 shows dispersion profiles of the protein in myoglobin (A), and of the heme in myoglobin (B) recorded under near-native solvent conditions. The fitted diffusion coefficients are indicated in each panel. Solid lines are fits to the experimental data based on equation 17.

FIG. 5 shows dispersion profiles of the protein in myoglobin (A), and of the heme in myoglobin (B) recorded under denaturing solvent conditions (50% acetonitrile, pH 10.0). Panel (C) shows the dispersion profile of heme recorded under the same solvent conditions but in the absence of protein. The fitted diffusion coefficients D are indicated in each panel. Solid lines are fits to the experimental data based on equation 17.

FIG. 6 shows dispersion profiles of the protein in myoglobin (A), and of the heme in myoglobin (B) recorded under “semi-denaturing” solvent conditions (30% acetonitrile, pH 10.0). Panel (C) shows the dispersion profile of heme recorded under the same solvent conditions, but in the absence of protein. The fitted diffusion coefficients D are indicated in each panel. Solid lines are fits to the experimental data based on equation 17.

FIG. 7 shows schematic ligand dispersion profiles calculated for a mixture of potential ligands. Only the profile of the potential ligands are shown, not that of the macromolecular target. (A) dispersion profile calculated in the presence of the target, none of the potential ligands binds to the target; (B) dispersion profile calculated in the presence of the target, one ligand (corresponding to the solid line) binds to the target.

FIG. 8 shows data obtained in an experiment where the dispersion profiles of six sugars (ribose, rhamnose, glucose, maltose, maltotriose, and chitotriose) were monitored simultaneously. Data were recorded for the sugar mixture alone, and for the sugar mixture in the presence of the protein lysozyme. The data depicted here represent the dispersion profiles of one particular sugar in this mixture, rhamnose, recorded in the absence (A) and in the presence (B) of lysozyme.

FIG. 9 shows data obtained in an experiment where the dispersion profiles of six sugars (ribose, rhamnose, glucose, maltose, maltotriose, and chitotriose) were monitored simultaneously. Data were recorded for the sugar mixture alone, and for the sugar mixture in the presence of the protein lysozyme. The data depicted here represent the dispersion profiles of one particular sugar in this mixture, chitotriose, recorded in the absence (A) and in the presence (B) of lysozyme.

FIG. 10 shows data obtained in an experiment where the dispersion profiles of six sugars (ribose, rhamnose, glucose, maltose, maltotriose, and chitotriose) were monitored simultaneously. The apparent diffusion coefficients of all sugars are shown, as measured in the absence (black) and presence (light grey) of the protein lysozyme. Note that only chitotriose shows a significant change upon addition of the protein. Also shown for comparison is the diffusion coefficient of lysozyme in the absence of sugars. Error bars represent standard deviations, each measured diffusion coefficient represents the average of about ten independent measurements.

### DETAILED DESCRIPTION OF THE INVENTION

Definitions

A method and apparatus using ESI-MS or APCI-MS has been developed to detect the noncovalent binding of potential ligands to targets. In a typical embodiment, any of the potential ligands will have a lower molecular weight than any of the targets, such that the diffusion of the ligand(s) in solution will be markedly slowed down upon binding to the target(s).

As used herein, the term “target” encompasses any naturally occurring or synthetic chemical or biochemical species that can bind noncovalently, or that could potentially bind noncovalently, to the ligand(s) of interest. Examples of possible targets include macromolecular compounds such as proteins, multi-protein complexes, nucleic acids, cellular receptors, and also lipids. The term “target” also encompasses molecular or supramolecular assemblies, such as membrane patches or membrane vesicles. It also encompasses larger systems, such as organelles or even whole cells.

As used herein, the term “ligand” encompasses any naturally occurring or synthetic chemical or biochemical species that can bind noncovalently, or that could potentially bind noncovalently, to the target(s) of interest. Examples of possible ligands include metal ions, amino acids, peptides, porphyrin compounds, sugars (mono- and oligosaccharides), mono- and oligonucleotides, lipids, secondary plant metabolites, enzyme inhibitors and cofactors, hormones, agonists and antagonists, vitamins, synthetic drugs, synthetic drug candidates, etc. All these molecular species may be referred to as “potential ligands” in cases where their binding behavior to the target of interest has yet to be determined.

As used herein, the terms “high-throughput screening” or “HTS” refer to assays involving the exposure of one or several target(s) to a group (or library) of potential ligands in an automated fashion, wherein the noncovalent binding of the potential ligand(s) to the target(s) is assayed for.

The terms “electrospray ionization mass spectrometry” (ESI-MS) and “atmospheric pressure ionization mass spectrometry” (APCI-MS) refer to processes wherein ions are formed from analyte molecules in solution, and subsequently analyzed mass spectrometrically (Loo, Bioconjugate Chem. 6, 644 (1995)).

As used herein, the term “analyte” refers to any ligand, potential ligand, or target that can be analyzed by ESI-MS or APCI-MS.

As used herein, the term “analyte solution” refers to a solution containing any ligand, potential ligand, target or any combination thereof.

As used herein, the term “carrier solution” refers to a solution that may contain any ligand, potential ligand, target or any combination thereof, but the composition of the carrier solution will be different from that of the analyte solution.

Theoretical Background—Taylor Dispersion.

Initially, an ESI-MS-based method will be described that allows measuring the diffusion coefficient of analyte species in solution (Clark, Rapid Comm. Mass Spectrom. 16, 1454 (2002)). This method is based on a flow technique involving analyte dispersion in a capillary tube (Taylor, Proc. Roy. Soc. Lond. A219, 186 (1953)). The velocity profile v(r) inside the tube depends on the Reynolds number [symbol] =\overline{v}dρ/η where \overline{v} is the average flow velocity, d is the tube diameter, and ρ is the density. For [symbol] <<2000, the flow inside the tube is laminar. Under these conditions the velocity profile v(r) in a circular tube is parabolic and is given by

$$v ( r ) = {v}_{0} ( 1 - \frac{{r}^{2}}{{R}^{2}} ) \qquad ( 1 )$$

where R and r are the inner radius and distance from the center of the tube, respectively. Liquid at the centerline of the tube (r=0) moves with the maximum velocity v₀, which is twice the average flow velocity \overline{v}, while the liquid at the tube wall (r=R) is stationary. Diffusive and convective transport of analyte under these conditions is governed by the equation

$$D ( \frac{{\partial }^{2} C}{\partial {r}^{2}} + \frac{1}{r} \frac{\partial C}{\partial r} + \frac{{\partial }^{2} C}{\partial {x}^{2}} ) = \frac{\partial C}{\partial t} + {v}_{0} ( 1 - \frac{{r}^{2}}{{R}^{2}} ) \frac{\partial C}{\partial x} , \qquad ( 2 )$$

which can be integrated for any set of initial conditions to give the analyte concentration C(r,x,t) as a function of radial position r, longitudinal position x, and time t. A short plug of concentrated analyte solution that is injected into a moving stream of carrier solution tends to be dispersed by the variable flow velocity across the tube cross section. However, radial diffusion will cause analyte molecules to exchange between zones of higher and lower flow velocity, thus counteracting the dispersion caused by the velocity profile. Diffusion along the tube is completely negligible for liquid solutions under typical operating conditions.

Taylor (Proc. Roy. Soc. Lond. A219, 186 (1953)) provided the first detailed analysis of combined convective and diffusive analyte transport, which is often referred to as “Taylor dispersion”. The average concentration of the analyte at a distance x=l downstream from the injection point can be measured optically by monitoring changes of the absorbance, the fluorescence intensity, or the refractive index, as a function of time t. By fitting measured dispersion profiles to solutions of Equation 2, the diffusion coefficient D of the analyte can be determined. For the described scenario, where a short sample plug is injected into a laminar stream of carrier solution, the dispersion profile will exhibit a Gaussian shape. A large diffusion coefficient D will decrease the width of the measured peak because radial diffusion suppresses the dispersive effects of the laminar velocity profile. In the literature, this kind of diffusion experiment is known as the “peak broadening method”.

In a variation of this pulse injection method, an initially sharp step function boundary is formed between the carrier solution and a “semi-infinite slug” of analyte solution. The dispersion profile is monitored at a distance x=l downstream from the initial location of the solution boundary. The dispersion profiles generated under these conditions have a sigmoidal appearance; the steepness of the measured curves increases with increasing values of D. The use of optical detection methods in traditional Taylor dispersion experiments results in a high sensitivity but poor selectivity because it is usually not possible to resolve the contributions from different analytes to the measured dispersion profiles.

The analyte concentration C(r,x,t) in a circular flow tube (inner radius R, length l) is a function of radial position r, axial position x, and time t Taylor (Proc. Roy. Soc. Lond. A219, 186 (1953)) has derived equations for the evaluation of C(r,x,t) for dispersion profiles generated from an initially sharp boundary between a solvent (zero analyte concentration) and a following solution (analyte concentration C₀) located at position x=0 for t=0.

C(r,x,0)=C₀ (x≦0)

C(r,x,0)=0 (x>0) (3).

For these initial conditions and laminar flow C(r,x,t) is given by

$$\begin{matrix}\begin{matrix}C ( r , x , t ) = \overline{C} ( x , t ) + \frac{{R}^{2} {v}_{0}}{4 D} \frac{\partial \overline{C} ( x , t )}{\partial x} ( - \frac{1}{3} + {z}^{2} - \frac{1}{2} {z}^{4} ) + \\ g ( z ) \frac{{\partial }^{2} \overline{C} ( x , t )}{\partial {x}^{2}}\end{matrix} & ( 4 ) \\ where z = r / R , & \\ g ( z ) = \frac{{R}^{4} {v}_{0}^{2}}{16 {D}^{2}} \{ \frac{1}{16} {z}^{8} - \frac{5}{18} {z}^{6} + \frac{1}{4} {z}^{2} + \frac{31}{16 \times 5 \times 9} \} & ( 5 ) \\ and & \\ \overline{C} ( x , t ) = \frac{{C}_{0}}{2} [ 1 + erf ( \frac{1}{2} {x}_{1} {k}^{- 1 / 2} {t}^{- 1 / 2} ) ] & ( 6 )\end{matrix}$$

is the analyte concentration averaged over the cross section of the tube at time t and distance x downstream from the initial boundary. In Equation 6, x₁ and k are given by

$$\begin{matrix}{x}_{1} = x - \frac{1}{2} {v}_{0} t , & ( 7 ) \\ k = \frac{{R}^{2} {v}_{0}^{2}}{192 D} & ( 8 )\end{matrix}$$

and erf(z) is the error function

$$erf ( z ) = ( 2 {π}^{- 1 / 2} ) {\int }_{0}^{z} {ⅇ}^{- {z}^{2}} ⅆ z . \qquad ( 9 )$$

Taylor dispersion studies require conditions where the flow tube length l is sufficient so that radial concentration variations due to convection are significantly reduced by diffusion. This was shown to be the case if

$$\frac{l}{\overline{v}} > \frac{50 {R}^{2}}{{3.8}^{2} D} . \qquad ( 10 )$$

Previous work (Konermann, J. Phys. Chem. A 103, 7210 (1999)) has shown that two types of detectors have to be distinguished for flow tube experiments. An ESI mass spectrometer represents a “type I” detector that monitors a count rate

$$\dot{N} ( t ) = {lim}_{Δ t -> 0} \frac{Δ N}{Δ t} ( t ) , \qquad ( 11 )$$

defined as the number of analyte molecules ΔN that pass through a cross-sectional plane located at the outlet of the flow tube per time interval Δt. The count rate measured by a type I detector is governed by the concentration C(r,l,t) at the outlet of the tube and by the radial variations of the flow velocity v(r) (Equation 1). The dispersion profile for a type I detector can therefore be calculated as follows. A total of dN analyte molecules will flow through a ring of inner radius r, and outer radius r+dr per time interval Δt.

dN=C(r,l,t)dV (12),

where

dV=2πrdr·v(r)·Δt (13)

is the volume that flows through the ring during the time interval Δt and thus

dN=C(r,l,t)·2πrdr·v(r)·Δt (14).

In this equation it is assumed that the concentration profile ^{C(r,l,t)} can be considered constant during the short time interval Δt. With Equation (1), (14) can be expressed as

$$ⅆ N = 2 π {v}_{0} C ( r , l , t ) ( r - \frac{{r}^{3}}{{R}^{2}} ) ⅆ r \cdot Δ t . \qquad ( 15 )$$

The total number of particles ΔN that are detected per time interval Δt is obtained by integration over the cross-sectional area of the flow so that

$$Δ N = 2 π {v}_{0} {\int }_{0}^{R} C ( r , l , t ) ( r - \frac{{r}^{3}}{{R}^{2}} ) ⅆ r \cdot Δ t . \qquad ( 16 )$$

The dispersion profile monitored by a type I detector is therefore

$$\dot{N} ( t ) = {lim}_{Δ t -> 0} \frac{Δ N}{Δ t} = 2 π {v}_{0} {\int }_{0}^{R} C ( r , l , t ) ( r - \frac{{r}^{3}}{{R}^{2}} ) ⅆ r . \qquad ( 17 )$$

Optical devices that measure refractive index, absorbance, or fluorescence profiles are “type II” detectors that monitor ^{\overline{C}(l,t)}, the analyte concentration at a position x=l, averaged over the cross-sectional area of the flow tube

$$\overline{C} ( l , t ) = \frac{2}{{R}^{2}} {\int }_{0}^{R} C ( r , l , t ) r ⅆ r . \qquad ( 18 )$$

Traditional Taylor dispersion studies are carried out by using type II detectors. The theory underlying these experiments is well understood, however, the use of an ESI mass spectrometer (type I detector) for this purpose has only recently been described by Clark and Konermann (Rapid Comm. Mass Spectrom. 16, 1454 (2002)). It can be shown that the differences between type I and type II detectors become negligible if

$$\frac{l}{\overline{v}} > \frac{500 {R}^{2}}{{3.8}^{2} D} . \qquad ( 19 )$$

Taylor dispersion experiments with type I detection carried out under conditions satisfying this condition have the advantage that the data analysis is more straightforward. In this case the simple expression derived for type II detection (Equation 6) is also valid for type I detectors. However, experiments carried out under these conditions have the disadvantage that (for given values of l, R and D) the flow velocity ^{\overline{v}} required to satisfy condition 19 is up to ten times lower than that required for condition 10, thus increasing the total time required for the analysis significantly. In many cases it will therefore be preferable to carry out type I diffusion experiment under conditions that satisfy condition 10, but not condition 19. In this case, the time required to record type I dispersion profiles is as short as possible, but the data analysis has to be based on the more complex expression given in Equation (17).

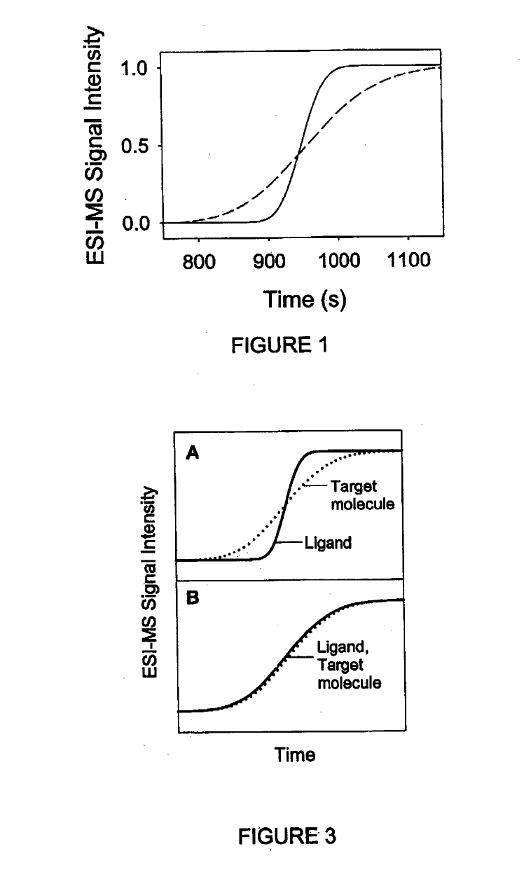

From now on we shall only focus on dispersion profiles that were recorded by an ESI mass spectrometer or by an APCI mass spectrometer, both of which represent type I detectors. All the measured and calculated dispersion profiles will be displayed on a scale that has been normalized to cover a relative intensity scale from zero to one. Due to this normalization the equations derived above apply in our case, although the “background concentration” of the carrier solution is C₀/2, and not zero. The calculated curves depicted in FIG. 1 show that the appearance of a dispersion profile depends on the diffusion coefficient of the analyte. Large values of D will increase the steepness of the dispersion profile. This effect forms the basis for Taylor dispersion-based measurements of diffusion coefficients. Most of the experiments described below are based on the capability of ESI-MS to measure dispersion curves, and hence diffusion coefficients, of a number of analyte species simultaneously.

Apparatus

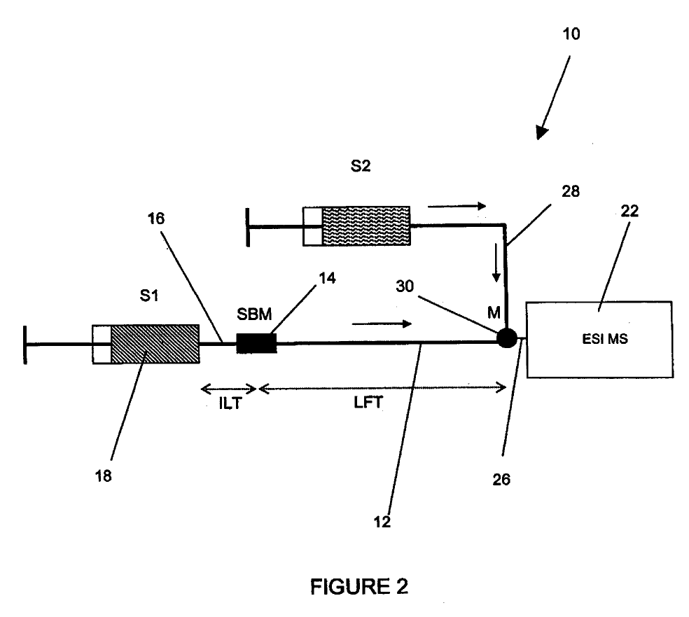

Based on the theoretical considerations described above, we will now describe details of an apparatus that allows the measurement of dispersion profiles by ESI-MS or APCI-MS. A schematic diagram of the apparatus is shown generally at 10 in FIG. 2. The measurements described below were carried out by using a 3.013 m long Teflon laminar flow tube (Upchurch, Oak Harbor, Wash.) shown as LFT or 12 in FIG. 2. The inner diameter (i.d.) of this LFT was determined gravimetrically to be 258.2 μm. In order to measure a diffusion coefficient, a sharp initial boundary must be created between the carrier solution and the following analyte solution at the entrance of the flow tube (Equation 3). This was accomplished by using a valve mechanism shown in FIG. 2 as a “sliding block mechanism (SBM)” 14 developed by the inventors. The laminar flow tube (LFT) 12 is inserted into a Teflon block machined to accommodate a PEEK connector and ferrule (Upchurch, Oak Harbor, Wash.) so that the flow tube 12 extends through to the end of the block. Initially, the entrance to the flow tube 12 is aligned with an opening in a steel block into which a piece of PEEK tubing 16 (508 μm ID, length ≈0.5 m) is fitted, using another PEEK connector and ferrule. This second piece of tubing 16 is used as the inlet tube, forming a leak-proof connection between the inlet tube and the flow tube at the boundary between the steel and Teflon blocks.

An analyte reservoir 18 (shown as a syringe in FIG. 2 which also acts as a pump) connected to the inlet tube 16 can be used to fill the inlet tube 16 with analyte solution, and to pump this analyte solution through the LFT 12. Initially, however, a carrier solution reservoir (not shown) is connected to tube 16 for filling the laminar flow tube 12 with carrier solution. The analyte solution and carrier solution reservoirs are never connected to the laminar flow tube 16 at the same time. Subsequently, the Teflon block containing the flow tube is moved sideways, such that the two tubes 12 and 16 are no longer aligned and the entrance to the flow tube 12 is closed off by the steel block. The inlet tube 16 can now be filled with analyte solution from pump 18 (syringe S1) without disturbing the carrier solution in the flow tube 12. Then the Teflon block is returned to its original position, aligning the two tubes (12 and 16) and creating a sharp boundary between the analyte solution in the inlet tube and the carrier solution in the LFT 12. The i.d. of the inlet tube 16 was chosen to be larger than that of the flow tube 12 to ensure that the boundary between the two solutions would cover the entire cross-sectional area of the flow tube 12, even if the sliding block were slightly misaligned. The use of a commercially available HPLC injection valve with a sample loop of suitable size may serve the same purpose as the described sliding block mechanism.

It is noted that in principle the measurements described herein could also be carried out under conditions that have the LFT 12 initially filled with analyte solution, and the inlet tube 16 initially filled with carrier solution which will result in analyte dispersion curves reversed as they appear in FIG. 1. In other words, the present invention can be used under conditions where all analyte dispersion profiles represent transitions from low signal intensities to high signal intensities (such as in the examples disclosed below), or it can be used under conditions where all analyte dispersion profiles represent transitions from high signal intensities to low signal intensities. Depending on the conditions used, it may also be possible that some analytes show transitions from low signal intensities to high signal intensities, whereas other analytes in the same solution show transitions from high signal intensities to low signal intensities.

An ESI-MS system 22, which includes an electrospray ion source located between the outlet of flow tube 12 and the inlet of the mass spectrometer in which the ions are produced by electrospray ionization, is spaced from the exit of laminar flow tube 12 with the mass spectrometer being configured so that when analyte solution is pumped through the laminar flow tube 12 dispersion profiles of the one or more chemical or biochemical analyte species present in the analyte solution are developed by monitoring signal intensities, measured by the mass spectrometer 22, of ions of one or more analytes (usually those of the potential ligands) being monitored simultaneously, as a function of time.

It will be appreciated by those skilled in the art that while an ESI-MS system is preferred for many possible applications, one could also produce the ions using APCI which requires a different ion source. Therefore the mass spectrometers used for ESI and APCI can be the same, it is just the ion source that is different but both are commercially available.

While the reservoir 18 is shown as a syringe for pumping analyte solution through tubes 16 and 12, the apparatus may also comprise a separate reservoir with a separate pump which may be controlled by a flow rate meter to ensure the analyte solution is flowed with a flow rate under conditions such that a Reynolds number [symbol] of <<2000 is maintained in order to maintain laminar flow. The laminar flow tube 12 may have an inner radius in a range from about 1 micrometer to about 1 cm and a length in a range from about 1 mm to about 100 m. The requirements for the tube length have been discussed in connection with equation 10 above.

Some solvent additives within the final solution mixture may interfere with the operation of the ESI or APCI source. Examples of such additives include many salts and chemical denaturants. Removal of these substances from the solution prior to ionization can enhance the signal intensity and stability (Xu, Anal. Chem. 70, 3553 (1998)). The inventors therefore envision the possible use of a solvent purification step, such as on-line dialysis, close to the outlet of the laminar flow tube of the current invention.

Aspects of the invention can be automated. For example, the analyte solution handling may be automated using a handler programmed to automatically take samples from one or more sample sources. Such an autosampler can dramatically reduce the overall testing time, allowing a large number of compounds to be screened within a short period of time (HTS). The data analysis steps may also be automated. For example, an online computer may be utilized to examine the mass spectrometry results. Such equipment is commercially available and standard in the art.

For the four examples given below, the analyte solution from syringe S1 is pumped through the laminar flow tube by using a Harvard syringe pump (South Nattick, Mass.). The outlet of the flow tube 12 is connected to two fused silica capillaries 26 and 28 (i.d. 100 μm, o.d. 165 μm, Polymicro Technologies, Phoenix, Ariz.) at a mixer 30 located at the end of tube 12. The first of these capillaries 26 has a length of 5 cm and is connected to the ESI source of the mass spectrometer 22. For studies on myoglobin, the second capillary 28 was used to supplement the analyte near the end of the laminar flow tube 12 with a methanol/acetic acid (90:10 v/v) mixture from syringe S2 just before it reached the ESI ion source. This “make-up” solvent was delivered at a flow rate of 5 μL/min, for a total flow rate of 10 μL/min at the ion source. The residence time of the analyte solution in the final 5 cm capillary was only about 2 s and can therefore be neglected for the analysis (the value of l/\overline{v} is 1929 s). For experiments on sugar binding to lysozyme, the flow rate within the laminar flow tube was 10 μL/min. The second capillary 28 was used to supplement the analyte near the end of the laminar flow tube 12 with a methanol/acetic acid/10 mM aqueous LiCl (80:10:10 v/v/v) mixture from syringe S2 just before it reaches the ESI ion source. This “make-up” solvent was delivered at a flow rate of 10 μL/min, for a total flow rate of 20 μL/min at the ion source.

Dispersion profiles were recorded by monitoring the signal intensity of one or several ions as a function of time by multiple ion monitoring (MIM) on an API365 triple-quadrupole mass spectrometer 22 (Sciex, Concord, ON) by using a dwell time of 50 ms. Prior to data analysis, groups of 20 consecutive points were averaged, resulting in an effective dwell time of 1 s. Dispersion profiles of myoglobin were recorded by monitoring the intensity of [aMb+17 H]¹⁷⁺ at m/z 998.2 as a function of time. Heme⁺ was detected at m/z 616. Sugars were monitored as cationized species [sugar+Li]⁺. The carrier solutions were identical to the analyte solution, except that the analyte concentration was decreased by a factor of two. The relatively high concentration of analyte in the carrier solution was used as a precaution to avoid potential distortions of the dispersion profiles, caused by analyte adsorption on the flow tube walls. At ionic strengths close to zero, small variations in the salt content of the solution can significantly affect the diffusion behavior of highly charged macromolecules. To reduce the relative day-to-day variations in the ion content of the water used, ammonium acetate at a concentration of 1 mM was therefore added to all analyte solutions.

A least-squares computer program was written to fit diffusion coefficients to the experimental profiles based on Equation 17. The diffusion coefficients given below represent an average of about ten independent experiments. Experimental errors represent the standard deviation of these measurements. All experiments were carried out at a temperature of 24±1° C. Ammonium acetate, piperidine, myoglobin, lysozyme, ribose, rhamnose, glucose, maltose, maltotriose, and chitotriose were purchased from Sigma (St. Louis, Mo.). Acetic acid, HPLC grade methanol and acetonitrile were Fisher Scientific (Nepean, ON) products. These chemicals were used without further purification. Solutions were prepared with freshly distilled water pre-purified by reverse osmosis.

The principle of the current application is illustrated in FIG. 3. For reasons of simplicity, it is initially assumed that the solution studied contains only one type of target, and one type of potential ligand. The concentration of the target is assumed to be greater than or equal to that of the potential ligand. It is further assumed that the potential ligand is a “small molecule” with a molecular weight lower than that of the target (e.g. M_{ligand}≈3-5000 Da, M_{target}>10,000 Da). An extension of the method to include a number of potential ligands, and a number of targets, will be described below.

The dispersion profiles of both the potential ligand and the target are monitored simultaneously by ESI-MS. FIG. 3A represents the situation encountered in the absence of noncovalent binding. The diffusion of the two analytes is independent, and the two dispersion curves are therefore different; steep for the small molecule (large diffusion coefficient) and more extended for the target (small diffusion coefficient). However, the ligand will show a dispersion profile resembling that of the target if the two species form a noncovalent complex within the laminar flow tube (FIG. 3B). It is pointed out that measuring the dispersion profile of the target is not necessarily required for this approach. In many cases it will be simpler to initially measure dispersion profiles of potential ligand(s) in the absence of the target. Then the procedure is repeated in the presence of the target. Any change of the dispersion profile of the potential ligand from steep (in the absence of the target) to more extended (in the presence of the target) will indicate noncovalent binding of the ligand to the target.

The method may be simplified, by only monitoring the dispersion profile of the potential ligand in the presence of the target. It will usually be possible to estimate the diffusion coefficient (and therefore the expected dispersion profile) of the free potential ligand using a theoretical model. In the simplest case this can be done by using the relationship D=kT/6πaη), where k is the Boltzmann constant, T the absolute temperature, η the solvent viscosity, and a the radius of the potential ligand (assuming it to have a spherical shape). In some cases, more accurate models for calculating diffusion coefficients of the potential ligand(s) may be required. If this calculated profile is similar to the one that is observed experimentally, the potential ligand is not bound to the target in solution. A more extended profile, on the other hand, would indicate the formation of a noncovalent ligand-target complex.

For the described method to work, it is necessary to fragment any possible ligand-target interaction immediately prior to ionization (i.e. after the mixture has passed through the laminar flow tube), to make sure that the dispersion profiles of all analytes can be monitored separately. Referring again to FIG. 2, this can be achieved by denaturing the target through the addition of a “make-up solvent” from syringe S2, such as an organic cosolvent (e.g. methanol) and/or organic acid (e.g. acetic acid). In addition, the voltages in the ion sampling interface of the mass spectrometer can be adjusted to result in “harsh” desolvation conditions, which will induce fragmentation of noncovalent binding that may still persist after the addition of the make-up solvent.

The use of organic cosolvents and acids in the final analyte solution, as well as the employment of relatively “harsh” desolvation conditions often results in very high signal intensities, thus facilitating the analysis. The mass spectrometer can be used to monitor the dispersion profiles of the target and of the potential ligand(s) simultaneously.

The method of the present invention will now be illustrated by the following non-limiting examples, initially for the case of one type of target, and one type of potential ligand. Native holo-myoglobin represents a noncovalent complex consisting of a heme group (Mₕₑₘₑ=616 Da) that is bound to a protein (apo-myoglobin, Mₚᵣₒₜₑᵢₙ=16950 Da). Through the addition of organic cosolvents at basic pH, the noncovalent heme-protein interactions can be disrupted. In this scenario, apo-myoglobin represents the target, and heme represents the potential ligand.

### EXAMPLE 1

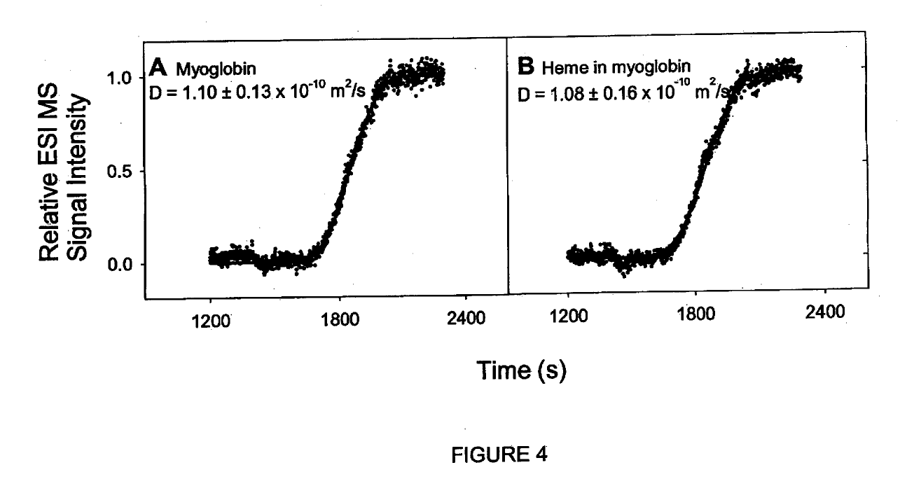

Myoglobin in the laminar flow tube is exposed to “native-like” solvent conditions (no organic cosolvents, pH 10). It is known from previous studies that under these conditions the heme group is noncovalently bound to the protein. FIG. 4 shows dispersion profiles of the protein in myoglobin (A), and of the heme in myoglobin (B). The fitted diffusion coefficients are indicated in each panel; they agree closely with each other, thus confirming that the heme is indeed noncovalently bound to the protein.

### EXAMPLE 2

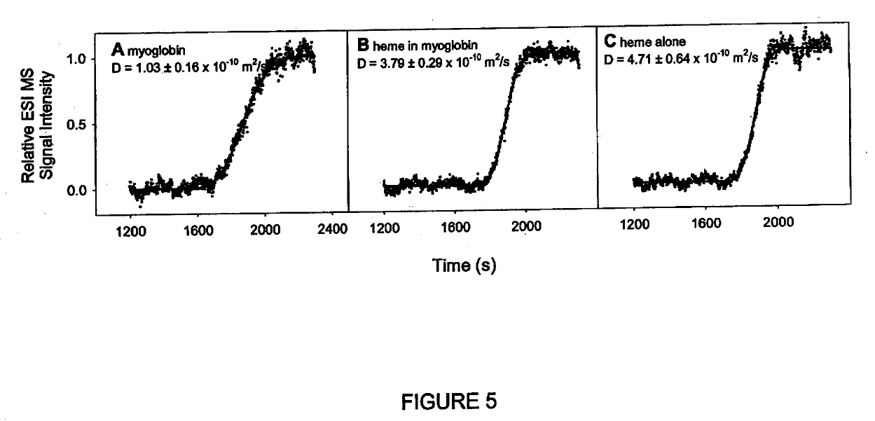

Myoglobin in the laminar flow tube is exposed to denaturing conditions (50% acetonitirile, pH 10). Under these conditions the heme group is not expected to bind to the protein. Referring to FIG. 5, dispersion profiles of the protein in myoglobin (A), and of the heme in myoglobin (B) were recorded. Panel (C) shows the dispersion profile of heme recorded under the same solvent conditions but in the absence of protein. The fitted diffusion coefficients D are indicated in each panel. Solid lines are fits to the experimental data based on equation 17. These dispersion profiles reveal a small diffusion coefficient for the protein, and a much larger diffusion coefficient for the heme, as expected. The diffusion coefficient D of heme in the protein solution is almost as large as that of heme in the protein-free solution (considering the experimental uncertainty in the measured value of D), thus confirming that noncovalent interactions between heme and the protein are absent or extremely weak.

### EXAMPLE 3

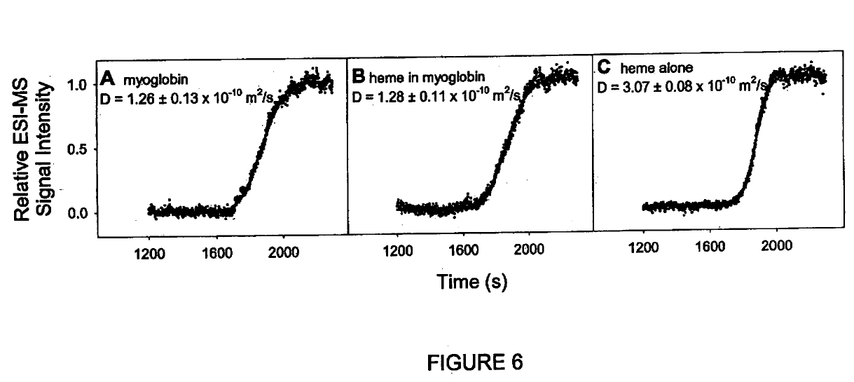

Myoglobin in the laminar flow tube is exposed to “semi-denaturing” conditions (30% acetonitrile, pH 10). FIG. 6 shows the dispersion profiles of the protein in myoglobin (A), and of the heme in myoglobin (B) recorded under these solvent conditions. Panel (C) shows the dispersion profile of heme recorded under the same solvent conditions but in the absence of protein. The fitted diffusion coefficients D are indicated in each panel. Solid lines are fits to the experimental data based on equation 17. The diffusion coefficients of heme and protein in the myoglobin solution are almost identical. A much larger diffusion coefficient is measured for heme in the absence of protein. These results show that under these semi-denaturing conditions, heme and protein are still bound to each other.

The findings presented in Examples 1, 2, and 3 are in agreement with the results of optical control experiments. It is pointed out that standard ESI-MS fails to detect the different noncovalent heme-protein interactions under the conditions of Experiments 2 and 3 (Clark, J. Am. Soc. Mass Spectrom. 14, 430 (2003)), thus confirming that the current invention can reveal interactions that go undetected when using other methods.

### EXAMPLE 4

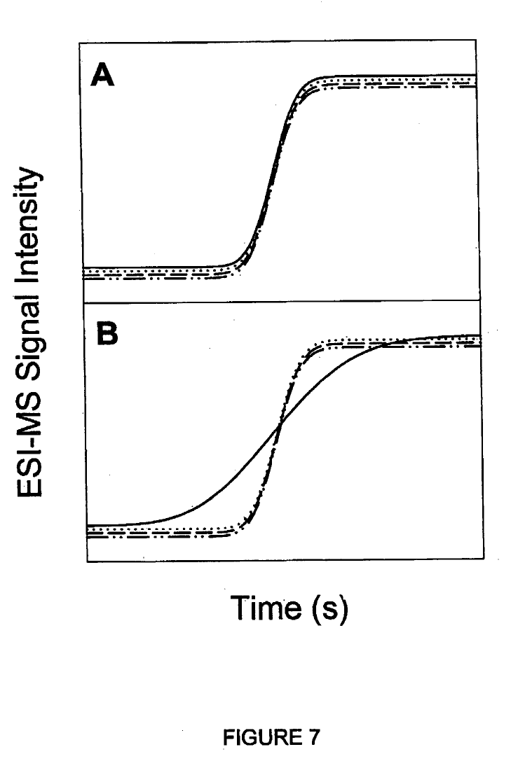

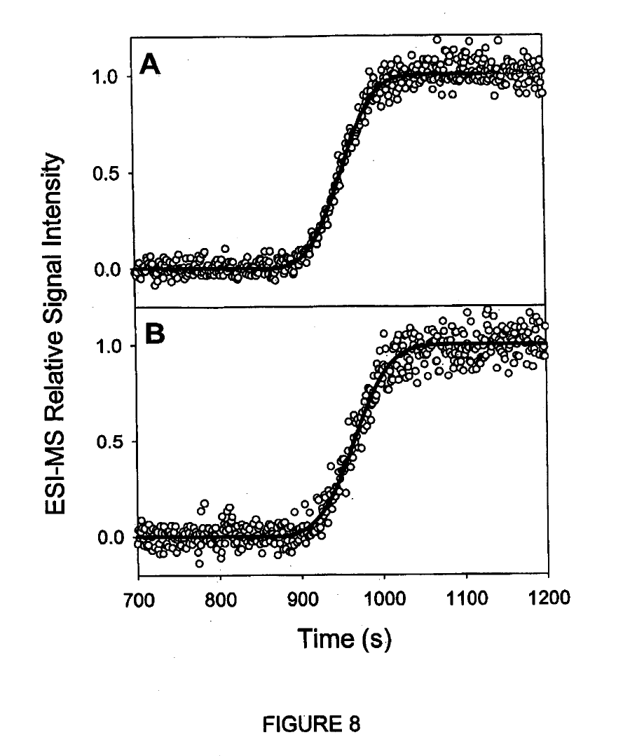

It will now be described how the present invention can be generalized to screen a number of potential ligands for binding to a particular target. The principle of this approach is schematically depicted in FIG. 7. An ESI mass spectrometer is used to monitor the dispersion profiles of a number of potential ligands simultaneously. All of these potential ligands are mixed in the same solution, initially in the absence of the target, resulting in the dispersion profiles shown in FIG. 7A. Note that all of the profiles are steep, due to the relatively small molecular size of the potential ligands. FIG. 7B shows a scenario where the experiment is repeated in the presence of the target. It is assumed that one of the ligands binds noncovalently to the target. The dispersion profile of this ligand (solid line in FIG. 7B) is much more extended than that of the other potential ligands, and it is also much more extended than the profile of this ligand recorded in the absence of the protein.

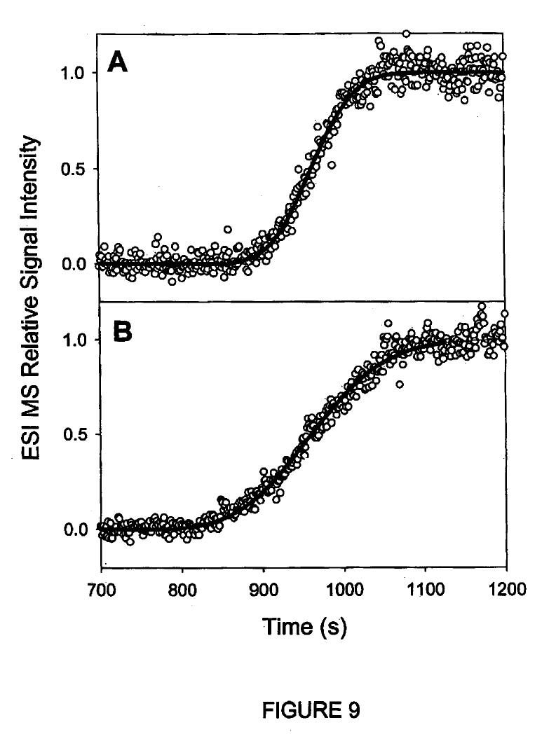

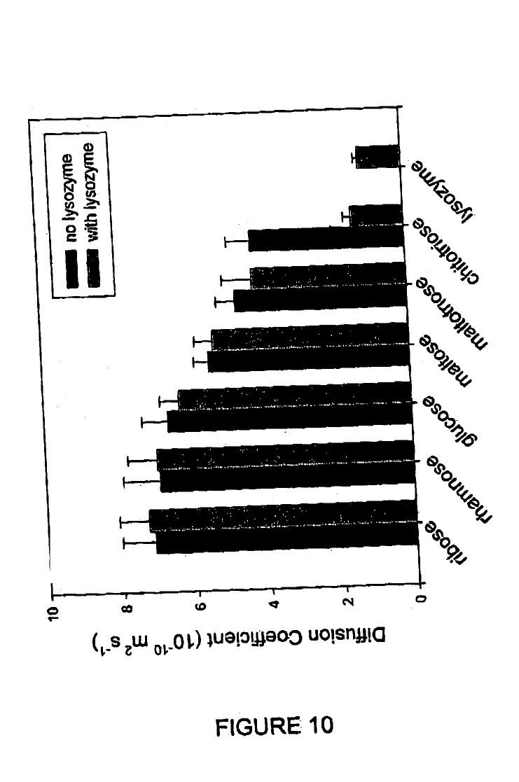

This approach will now be illustrated in an example where a mixture of six sugars is screened for binding to the protein lysozyme (Mₚᵣₒₜₑᵢₙ=14,304 Da). The six sugars tested are ribose, rhamnose, glucose, maltose, maltotriose, and chitotriose. This mixture represents potential ligands with molecular weights ranging from 150 Da (ribose) to 628 Da (chitotriose). Dispersion profiles of all sugars were measured simultaneously, i.e., all six potential ligands were present in the laminar flow tube at the same time. The experiments were first carried out without protein in the analyte mixture, and then they were repeated in the presence of lysozyme. Five of the sugars showed virtually no change in their dispersion profiles when the protein was added, thus indicating that none of them bind noncovalently to lysozyme. As an example, profiles obtained for one of these sugars, rhamnose, obtained without and with protein, are depicted in FIG. 8. Only chitotriose shows a distinct change in its profile, from relatively steep in the absence of lysozyme (FIG. 9A), to more extended in the presence of lysozyme (FIG. 9B). This observation shows that out of the six sugars tested, only chitotriose binds noncovalently to lysozyme. This finding is in agreement with previous data from the literature (Imoto, The Enzymes (Boyer, ed.) VII, Academic Press, New York, 665 (1972)). The data obtained in these experiments are summarized in FIG. 10, which shows the apparent diffusion coefficients of all six sugars, measured in the absence (black), and in the presence (light grey) of lysozyme. It is evident that only the diffusion coefficient of chitotriose shows a dramatic reduction upon addition of the protein. This is due to the formation of a noncovalent chitotriose-lysozyme complex.

In summary, the four examples outlined above clearly demonstrate the capability of the current invention to detect the specific noncovalent binding of ligands to a target by ESI-MS, without relying on the stability of ligand-protein interactions in the gas phase.

It will be appreciated by those skilled in the art, that a further generalization of the described approach for the analysis of mixtures of several potential ligands is straightforward. It will now be described an embodiment that allows the screening of a number of compounds by only monitoring one single dispersion profile. This is in contrast to the scenario of example 4 which required the measurement of multiple dispersion profiles. This strategy requires the presence of a “reference ligand” that is known to bind to the target. In the presence of the target, this reference ligand will show an extended profile, corresponding to a small diffusion coefficient. If the experiment is now repeated in the presence of a number of one or more other potential ligands, the reference compound may be displaced from the target by one or more other ligands. The release of the reference compound will dramatically increase its apparent diffusion coefficient, and therefore the steepness of its dispersion profile. While this strategy does not necessarily provide information on the identity of the newly identified ligand(s), it will be a useful step for the initial screening of a large number of compounds, to see if any of them have a significant affinity to the target. The identification of the ligand(s) that bind to the target can then proceed in a fashion analogous to Example 4.

In another embodiment, the method disclosed herein may be used for testing the binding of multiple potential ligands to multiple targets at the same time. In this scenario, dispersion profiles of each of the multiple potential ligands in a solution are initially recorded in the absence of any targets. Then the experiment is repeated in the presence of several targets. A comparison of the dispersion profiles obtained in the two experiments would reveal possible changes of these profiles, from steep profiles to more extended profiles. Any such changes would reveal which, if any, of the potential ligands bind to one or more of the targets in the solution. In an analogous fashion, it would be possible to study the possible binding of just one single potential ligand to a number of targets. This embodiment may be useful in cases where it is difficult, or undesirable, to separate mixtures that contain the several targets. One possible application is the analysis of cell extracts.

Thus, the present invention may be used for assaying for (i) the possible binding of one single potential ligand to one single target, (ii) the possible binding of a number of potential ligands to a single target, (iii) the possible binding of a number of potential ligands to a number of targets, and (iv) the possible binding of one single potential ligand to a number of targets.

Finally, it is pointed out that the examples shown have all been carried out for flow rate conditions, tube radii, tube lengths, and diffusion coefficients that satisfy relationship 10. The validity of this relationship ensures that an analysis of the measured dispersion profiles can be carried out, that results in apparent diffusion coefficients, based on Equations 4 and 17. In principle, however, it will also be possible use the present invention under conditions that do not satisfy relationship 10. The mathematical framework used for the analysis of the dispersion profiles will be different in that case. Nevertheless, the principle of the current invention will still apply; the noncovalent binding of a potential ligand to a target will induce a change of the ligand's ESI-MS or APCI-MS dispersion profile.

The inventors also contemplate that the invention disclosed herein may be used for the measurement of dissociation constants K_{d}. For the dissociation equilibrium of a noncovalent complex involving a target T and a ligand L,

$$TL ⇄ T + L , \qquad ( 20 )$$

K_{d} is defined as

$${K}_{d} = \frac{[ T ] [ L ]}{[ TL ]} . \qquad ( 21 )$$

The three concentrations in Equation (21), and therefore K_{d}, can be calculated if the fraction of free ligand f, the fraction of bound ligand (1−f), and the absolute concentrations of T, [T]₀, and the absolute concentration of L, [L]₀ in the solution are known. It has been suggested that the apparent diffusion coefficient Dₐₚₚ of the ligand L in the presence of the target T is simply given by the weighted average of D_{L} and D_{T} (Derrick, J. Mag. Res. 155, 225 (2002))

Dₐₚₚ=f×D_{L}+(1−f)×D_{T} (22),

where D_{L} is the diffusion coefficient of the free ligand L, and D_{T} is the diffusion coefficient of the target T. Dₐₚₚ, D_{L}, and D_{T} can be measured in three separate measurements, which allow the determination of f from Equation (23).

$$f = \frac{{D}_{app} - {D}_{T}}{{D}_{L} - {D}_{T}} . \qquad ( 23 )$$

K_{d} can then be calculated based on the following equation:

$${K}_{d} = \frac{( {[ T ]}_{0} - {[ L ]}_{0} ( 1 - f ) ) \times ( {[ L ]}_{0} f )}{{[ L ]}_{0} ( 1 - f )} \qquad ( 24 )$$

Instead of using Equation 22, it may also be possible to determine f based on Equation 25, expressing the dispersion profile (intensity vs. time, or I(t)) of the ligand in the presence of the target, Iₐₚₚ(t), as the weighted average of the dispersion profile of the free ligand, I_{L}(t), and that of the target, I_{T}(t), as described in Equation 25:

Iₐₚₚ(t)=f×I_{L}(t)+(1−f)×I_{T}(t) (25).

The fraction of free ligand, f, can be extracted from Equation 25, e.g., through the use of a non-linear least-square fitting algorithm. Once f is determined in this way, Equations 23 and 24 can be used for the detemination of K_{d} as described above.

The literature describes a number of cases where NMR spectroscopy has been employed for studying noncovalent interactions based on diffusion measurements. However, in contrast to the current invention, these experiments did not involve a laminar flow tube, instead they were carried out in bulk solution. The analyte concentrations required for NMR are very high, usually in the millimolar range. Especially for experiments involving proteins, nonspecific aggregation can become a problem at these concentrations. The analyte concentration required for the method using ESI-MS disclosed herein are usually in the micromolar range, i.e. three orders of magnitude lower. This represents an enormous advantage over NMR-based techniques.

As described above, Taylor dispersion experiments have been previously used for studying the diffusion behavior of analytes and analyte mixtures in laminar flow tubes. However, these traditional experiments all used optical detection methods, which makes it very difficult to analyze mixtures involving multiple analytes. The use of mass spectrometry for studying Taylor dispersion is a tremendous advance, since an almost unlimited number of different analytes can be monitored simultaneously with unsurpassed selectivity and extremely high sensitivity.

The present invention addresses the need to accurately assay a large number of potential ligands and targets within a relatively short time frame for their efficacy in forming noncovalent interactions. The present invention is therefore highly advantageous for use in the screening of entire compound libraries, e.g. in the context of HTS. It will be obvious to those skilled in the art that a miniaturization of the described technology, e.g. the use of a shorter and narrower flow tube, could drastically reduce the amount of material (solvent, potential ligand(s), target(s)) needed for these analyses. Such a miniaturization will also drastically decrease the time required for individual measurements, thus further enhancing the usefulness of the present invention for application in the area of HTS.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method of measuring diffusion coefficients of chemical or biochemical analyte species in solution, comprising the steps of:
a) injecting an analyte solution containing a chemical or biochemical analyte species into a first end of a laminar flow tube of selected length and flowing the analyte solution to a second end of the laminar flow tube;
b) converting said analyte solution exiting said laminar flow tube at the second end thereof to a gaseous spray of ions and transferring the ions within said gaseous spray into a mass spectrometer; and
c) developing a dispersion profile of the chemical or biochemical analyte species by monitoring signal intensities, measured by the mass spectrometer, of ions of the chemical or biochemical analyte species as a function of time, and determining an apparent diffusion coefficient of the chemical or biochemical analyte species in the laminar flow tube from the signal intensity versus time dispersion profile.

2. The method according to claim 1 wherein the ions are produced by electrospray ionization.

3. The method according to claim 1 wherein the ions are produced by atmospheric pressure chemical ionization.

4. The method according to claim 1 wherein the step of injecting an analyte solution containing a chemical or biochemical analyte species into one end of a laminar flow tube includes first filling the laminar flow tube with a carrier solution, and then connecting a source of the analyte solution to said first end of the laminar flow tube and injecting the analyte solution into the first end of the laminar flow tube, and forming an initially sharp boundary between a carrier solution and an analyte solution, and after the sharp boundary has been formed pumping the analyte and carrier solutions through the laminar flow tube to be expelled from the second end of the laminar flow tube.

5. The method according to claim 1 wherein the step of injecting an analyte solution containing a chemical or biochemical analyte species into one end of a laminar flow tube includes first filling the laminar flow tube with the analyte solution, and then connecting a source of carrier solution to said first end of the laminar flow tube and injecting the carrier solution into the first end of the laminar flow tube, and forming an initially sharp boundary between the analyte solution and the carrier solution, and after the sharp boundary has been formed pumping the analyte and carrier solutions through the laminar flow tube to be expelled from the second end of the laminar flow tube.

6. The method according to claim 1 wherein the analyte solution is flowed with a flow rate under conditions such that a Reynolds number less than 2000 is maintained, and wherein the laminar flow tube has an inner radius in a range from about 1 micrometer to about 1 cm.

7. A method for detecting noncovalent binding of a potential ligand to one or more targets, comprising:
a) injecting a first analyte solution containing one or more potential ligands to one or more targets into a first end of a laminar flow tube of selected length and flowing the first analyte solution to a second end of the laminar flow tube;
b) converting said first analyte solution exiting said laminar flow tube at the second end thereof to a gaseous spray of ions and transferring the ions within said gaseous spray into a mass spectrometer;
c) developing dispersion profiles of the one or more potential ligands by monitoring signal intensities, measured by the mass spectrometer, of ions of the one or more potential ligands as a function of time;
d) injecting a second analyte solution containing said one or more potential ligands and the one or more targets into the first end of the laminar flow tube and flowing the second analyte solution to the second end of the laminar flow tube;
e) converting said second analyte solution exiting said laminar flow tube at the second end thereof to a gaseous spray of ions and transferring the ions within said gaseous spray into the mass spectrometer after disrupting noncovalently bound complexes formed between the one or more potential ligands and the one or more targets;
f) developing dispersion profiles of the one or more potential ligands in the presence of the one or more targets by monitoring signal intensities, measured by the mass spectrometer, of ions produced in step e) of the one or more potential ligands as a function of time; and
g) detecting noncovalent binding between the one or more potential ligands and the one or more targets by comparing the dispersion profiles developed in step f) to the dispersion profiles developed in step c), wherein a noticeable change in dispersion profile of any of the one or more potential ligands is indicative of formation of a noncovalent complex between that potential ligand and one or more of the targets.

8. The method according to claim 7 wherein step c) includes a step of determining an apparent diffusion coefficient of the one or more potential ligands in the absence of the one or more targets in the laminar flow tube from the signal intensity versus time dispersion profile, and wherein step f) includes a step of determining an apparent diffusion coefficient of the one or more potential ligands in the presence of the one or more targets in the laminar flow tube from the signal intensity versus time dispersion profile, and wherein the step g) of detecting noncovalent binding between the one or more potential ligands and the one or more targets by comparing the dispersion profiles developed in step f) to the dispersion profiles developed in step c) includes comparing the apparent diffusion coefficients of each of the one or more potential ligands in the presence and absence of the one or more targets wherein a noticeable change in apparent diffusion coefficient of any of the one or more potential ligands is indicative of formation of a noncovalent complex between that potential ligand and one or more of the targets.

9. The method according to claim 7 wherein the steps a) and d) of injecting the respective first and second analyte solutions into one end of a laminar flow tube includes first filling the laminar flow tube with a carrier solution, and then connecting a source of the respective first or second analyte solution to said first end of the laminar flow tube and injecting the respective analyte solution into the first end of the laminar flow tube, and forming an initially sharp boundary between a carrier solution and the respective analyte solution, and after the sharp boundary has been formed pumping the analyte and carrier solutions through the laminar flow tube to be expelled from the second end of the laminar flow tube.

10. The method according to claim 7 wherein the steps a) and d) of injecting the respective first and second analyte solutions into one end of a laminar flow tube includes first filling the laminar flow tube with the respective first or second analyte, and then connecting a source of carrier solution to said first end of the laminar flow tube and injecting carrier solution, and forming an initially sharp boundary between a carrier solution and the respective analyte solution, and after the sharp boundary has been formed pumping the analyte and carrier solutions through the laminar flow tube to be expelled from the second end of the laminar flow tube.

11. The method according to claim 7 wherein the step of disrupting noncovalently bound complexes includes injecting a suitable solvent into the laminar flow tube near the second end thereof which contains one or more chemical compounds that disrupt noncovalently bound complexes present in the analyte solution.

12. The method according to claim 7 wherein the step of disrupting noncovalently bound complexes includes selecting effective voltages in an ion sampling interface of the mass spectrometer for disrupting noncovalently bound complexes present in the gas phase.

13. The method according to claim 7 wherein the step of disrupting noncovalently bound complexes includes exposing the gaseous spray of ions to conditions suitable for disrupting noncovalently bound complexes present in the gas phase prior to the gaseous spray of ions being transferred into the mass spectrometer.

14. The method according to claim 7 wherein the ions are produced by electrospray ionization.

15. The method according to claim 7 wherein the ions are produced by atmospheric pressure chemical ionization.

16. The method according to claim 7 wherein the analyte solution is flowed with a flow rate under conditions such that a Reynolds number of less than 2000 is maintained, and wherein the laminar flow tube has an inner radius in a range from about 1 micrometer to about 1 cm.

17. The method according to claim 7 including a step of purifying the first and second analyte solutions close to the second of the laminar flow tube prior to converting said first and second analyte solutions exiting said laminar flow tube at the second end thereof to a gaseous spray of ions in order to remove constituents of the analyte solution which may interfere with the ionization process or with the operation the mass spectrometer.

18. The method according to claim 17 wherein the step of purifying the first and second analyte solutions includes on-line dialysis, close to the second end of the laminar flow tube.

19. A method for detecting noncovalent binding of a potential ligand to a target, comprising:
a) injecting a first analyte solution containing one or more potential ligands to a target into a first end of a laminar flow tube of selected length and flowing the first analyte solution to a second end of the laminar flow tube;
b) converting said first analyte solution exiting said laminar flow tube at the second end thereof to a gaseous spray of ions and transferring the ions within said gaseous spray into a mass spectrometer;
c) developing dispersion profiles of the one or more potential ligands by monitoring signal intensities, measured by the mass spectrometer, of ions of the one or more potential ligands as a function of time;
d) injecting a second analyte solution containing said one or more potential ligands and the target into the first end of the laminar flow tube and flowing the second analyte solution to the second end of the laminar flow tube;
e) converting said second analyte solution exiting said laminar flow tube at the second end thereof to a gaseous spray of ions and transferring the ions within said gaseous spray into the mass spectrometer after disrupting noncovalently bound complexes formed between the one or more potential ligands and the target;
f) developing dispersion profiles of the one or more potential ligands in the presence of the target by monitoring signal intensities, measured by the mass spectrometer, of ions produced in step e) of the one or more potential ligands as a function of time; and
g) detecting noncovalent binding between the one or more potential ligands and the target by comparing the dispersion profiles developed in step f) of potential ligands in the presence of the target to the dispersion profiles developed in step c) of the potential ligands in the absence of the target wherein a noticeable change in dispersion profile of any of the one or more potential ligands is indicative of formation of a noncovalent complex between that potential ligand and the target.

20. A method for detecting noncovalent binding of a potential ligand to one or more targets, comprising the steps of:
a) determining a dispersion profile under laminar flow conditions for each of one or more potential ligands in an analyte solution;
b) injecting an analyte solution containing said one or more potential ligands and one or more targets into the first end of the laminar flow tube and flowing the analyte solution to the second end of the laminar flow tube;
c) converting said analyte solution exiting said laminar flow tube at the second end thereof to a gaseous spray of ions and transferring the ions within said gaseous spray into the mass spectrometer after disrupting noncovalently bound complexes formed between the one or more potential ligands and the one or more targets;
d) developing dispersion profiles of the one or more potential ligands in the presence of the one or more targets by monitoring signal intensities, measured by the mass spectrometer, of ions produced in step c) of the one or more potential ligands as a function of time; and
e) detecting noncovalent binding between the one or more potential ligands and the one or more targets by comparing the dispersion profiles developed in step d) of potential ligands in the presence of the one or more targets to known dispersion profiles for said one or more potential ligands in the absence of the one or more targets wherein a noticeable change in dispersion profile of any of the one or more potential ligands is indicative of formation of a noncovalent complex between that potential ligand and one or more of the targets.

21. The method according to claim 20 wherein the step of determining a dispersion profile under laminar flow conditions for each of one or more potential ligands includes using an effective theoretical model to calculate a diffusion coefficient for each of the one or more potential ligands, and from each of said calculated diffusion coefficient calculating a corresponding dispersion profile for each potential ligand.

22. The method according to claim 21 wherein step f) includes a step of determining an apparent diffusion coefficient of the one or more potential ligands in the presence of the one or more targets in the laminar flow tube from the signal intensity versus time dispersion profile, and wherein the step g) of detecting noncovalent binding between the one or more potential ligands and the one or more targets by comparing the dispersion profiles developed in step f) to the dispersion profiles developed in step c) includes comparing the apparent diffusion coefficients of each the one or more potential ligands in the presence of the one or more targets to the calculated diffusion coefficient for each of the one or more potential ligands, wherein a noticeable difference between the apparent diffusion coefficient and the calculated diffusion coefficient of any of the one or more potential ligands is indicative of formation of a noncovalent complex between that potential ligand and one or more of the targets.

23. The method according to claim 20 wherein the step of determining a dispersion profile under laminar flow conditions for each of one or more potential ligands includes
f) injecting a test analyte solution containing one or more potential ligands to a target into a first end of a laminar flow tube of selected length and flowing the test analyte solution to a second end of the laminar flow tube;
g) converting said test analyte solution exiting said laminar flow tube at the second end thereof to a gaseous spray of ions and transferring the ions within said gaseous spray into a mass spectrometer;
h) developing dispersion profiles of the one or more potential ligands by monitoring signal intensities, measured by the mass spectrometer, of ions of the one or more potential ligands as a function of time.

24. The method according to claim 23 wherein step h) includes a step of determining an apparent diffusion coefficient of the one or more potential ligands in the absence of the one or more targets in the laminar flow tube from the signal intensity versus time dispersion profile, and wherein step d) includes a step of determining an apparent diffusion coefficient of the one or more potential ligands in the presence of the one or more targets in the laminar flow tube from the signal intensity versus time dispersion profile, and wherein the step e) of detecting noncovalent binding between the one or more potential ligands and the one or more targets by comparing the dispersion profiles developed in step d) to the dispersion profiles developed in step h) includes comparing the apparent diffusion coefficients of each the one or more potential ligands in the presence and absence of the one or more targets wherein a noticeable change in apparent diffusion coefficient of any of the one or more potential ligands is indicative of formation of a noncovalent complex between that potential ligand and one or more of the targets.

25. The method according to claim 20 wherein the step of disrupting noncovalently bound complexes includes injecting a suitable solvent into the laminar flow tube near the second end thereof which contains one or more chemical compounds that disrupt noncovalently bound complexes present in the analyte solution.

26. The method according to claim 20 wherein the step of disrupting noncovalently bound complexes includes selecting effective voltages in an ion sampling interface of the mass spectrometer for disrupting noncovalently bound complexes present in the gas phase.

27. The method according to claim 20 wherein the step of disrupting noncovalently bound complexes includes exposing the gaseous spray of ions to conditions suitable for disrupting noncovalently bound complexes present in the gas phase prior to the gaseous spray of ions being transferred into the mass spectrometer.

28. The method according to claim 20 wherein the ions are produced by electrospray ionization.

29. The method according to claim 20 wherein the ions are produced by atmospheric pressure chemical ionization.

30. The method according to claim 20 wherein the analyte solution is flowed with a flow rate under conditions such that a Reynolds number of less than 2000 is maintained, and wherein the laminar flow tube has an inner radius in a range from about 1 micrometer to about 1 cm.

31. A method for detecting noncovalent binding between a target and one or more potential ligands, comprising:
a) injecting a first analyte solution containing a test ligand and a target known to bind with said test ligand into a first end of a laminar flow tube of selected length and flowing the analyte solution to a second end of the laminar flow tube;
b) converting said first analyte solution exiting said laminar flow tube at the second end thereof to a gaseous spray of ions and transferring the ions within said gaseous spray into the mass spectrometer after disrupting noncovalently bound complexes formed between the test ligand and the target;
c) developing a first dispersion profile of the test ligand by monitoring signal intensities, measured by the mass spectrometer, of ions of the test ligand as a function of time;
d) injecting a second analyte solution containing said target and said test ligand and one or more potential ligands in addition to the test ligand into the first end of the laminar flow tube and flowing the analyte solution to the second end of the laminar flow tube;
e) converting said second analyte solution exiting said laminar flow tube at the second end thereof to a gaseous spray of ions and transferring the ions within said gaseous spray into the mass spectrometer after disrupting noncovalently bound complexes formed between the target and any of said test ligand and one or more ligands in addition to the test ligand;
f) developing a second dispersion profile of the test ligand by monitoring signal intensities, measured by the mass spectrometer, of ions of the test ligand as a function of time; and
g) comparing said first and second dispersion profiles wherein a noticeable difference between the first and second dispersion profiles of the test ligand is indicative of formation of a noncovalent complex between the target and said one or more potential ligands.

32. The method according to claim 31 wherein the steps a) and d) of injecting the respective first and second analyte solutions into one end of a laminar flow tube includes first filling the laminar flow tube with a carrier solution, and then connecting a source of the respective first or second analyte solution to said first end of the laminar flow tube and injecting the respective analyte solution into the first end of the laminar flow, and forming an initially sharp boundary between a carrier solution and the respective analyte solution, and after the sharp boundary has been formed pumping the analyte and carrier solutions through the laminar flow tube to be expelled from the second end of the laminar flow tube.

33. The method according to claim 31 wherein the steps a) and d) of injecting the respective first and second analyte solutions into one end of a laminar flow tube includes first filling the laminar flow tube with the respective first or second analyte, and then connecting a source of carrier solution to said first end of the laminar flow tube and injecting carrier, and forming an initially sharp boundary between a carrier solution and the respective analyte solution, and after the sharp boundary has been formed pumping the analyte and carrier solutions through the laminar flow tube to be expelled from the second end of the laminar flow tube.

34. The method according to claim 31 wherein step c) includes a step of determining an apparent diffusion coefficient of the one or more potential ligands in the absence of the one or more targets in the laminar flow tube from the signal intensity versus time dispersion profile, and wherein step f) includes a step of determining an apparent diffusion coefficient of the one or more potential ligands in the presence of the one or more targets in the laminar flow tube from the signal intensity versus time dispersion profile, and wherein the step g) of detecting noncovalent binding between the one or more potential ligands and the one or more targets by comparing the dispersion profiles developed in step f) to the dispersion profiles developed in step c) includes comparing the apparent diffusion coefficients of each the one or more potential ligands in the presence and absence of the one or more targets wherein a noticeable change in apparent diffusion coefficient of any of the one or more potential ligands is indicative of formation of a noncovalent complex between that potential ligand and one or more of the targets.

35. The method according to claim 31 wherein the step of disrupting noncovalently bound complexes includes injecting a suitable solvent into the laminar flow tube near the second end thereof which contains one or more chemical compounds that disrupt noncovalently bound complexes present in the analyte solution.

36. The method according to claim 31 wherein the step of disrupting noncovalently bound complexes includes selecting effective voltages on an ion sampling interface of the mass spectrometer for disrupting noncovalently bound complexes present in the gas phase.

37. The method according to claim 31 wherein the step of disrupting noncovalently bound complexes includes exposing the gaseous spray of ions to conditions suitable for disrupting noncovalently bound complexes present in the gas phase prior to the gaseous spray of ions being transferred into the mass spectrometer.

38. The method according to claim 31 wherein the ions are produced by electrospray ionization.

39. The method according to claim 31 wherein the ions are produced by atmospheric pressure chemical ionization.

40. The method according to claim 31 wherein the analyte solution is flowed with a flow rate under conditions such that a Reynolds number less than 2000 is maintained, and wherein the laminar flow tube has an inner radius in a range from about 1 micrometer to about 1 cm.

41. An apparatus for measuring dispersion profiles of one or more chemical or biochemical analyte species in solution, comprising:
a) a mass spectrometer having an inlet;
b) a laminar flow system including
a laminar flow tube of selected length having an inlet and an outlet, the outlet being in flow communication with the inlet of said spectrometer, and the inlet of the laminar flow tube being in flow communication with a source of the analyte liquid mixture or a source of a carrier solution,
a valve mechanism connected to the inlet of the laminar flow system for controlling liquid flow from the source of the analyte liquid mixture or the source of the carrier solution, the valve mechanism having a structure that facilitates the creation of a sharp liquid boundary between analyte liquid mixture at the inlet of the laminar flow tube and carrier solution located downstream of the inlet in the laminar flow tube prior to pumping the analyte liquid mixture through the laminar flow tube,
a pump for pumping liquid through the laminar flow tube; and
c) the mass spectrometer being configured so that when liquid is pumped through the laminar flow tube dispersion profiles of the one or more chemical or biochemical analyte species present in the analyte liquid mixture are developed by monitoring signal intensities, measured by the mass spectrometer, of one or more ions of the one or more potential ligands as a function of time.

42. The apparatus according to claim 41 including an electrospray ion source located between the outlet of the laminar flow tube and the inlet of the mass spectrometer for generating the ions in the gas phase.

43. The apparatus according to claim 41 including an atmospheric pressure chemical ion source located between the outlet of the laminar flow tube and the inlet of the mass spectrometer for generating the ions in the gas phase.

44. The apparatus according to claim 41 including a mixer located near the outlet of the laminar flow tube for mixing liquid being pumped through the laminar flow tube with a liquid solution containing an agent which disrupts complexes, formed due to noncovalent interactions among the one or more chemical or biochemical analyte species, prior to entering the electrospray ionization apparatus.

45. The apparatus according to claim 41 including an solvent purification apparatus connected to the laminar flow tube near the second end thereof for purifying solutions close to the second end of the laminar flow tube in order to remove constituents of the analyte solution which may with the ionization process or with the operation the mass spectrometer.

46. The apparatus according to claim 45 wherein the solvent purification apparatus includes a dialysis system.

47. The apparatus according to claim 41 wherein the laminar flow system includes a laminar inlet tube having an inlet in flow communication with the source of the analyte liquid mixture and an outlet, and wherein the valve mechanism is connected to said laminar flow tube inlet and said laminar inlet tube outlet for controlling liquid flow between the laminar inlet tube and the laminar flow tube, the valve mechanism including a tube alignment mechanism for holding the laminar flow tube inlet and the laminar inlet tube outlet in position and moving the laminar flow tube inlet and the laminar inlet tube outlet into and out of alignment such that when in alignment the laminar flow tube and the laminar inlet tube are coaxially aligned whereby liquid flows from the laminar inlet tube into the laminar flow tube and when out of alignment no liquid flows from the laminar inlet tube into the laminar flow tube.

48. The apparatus according to claim 41 wherein the pump includes a pump controller for controlling the flow rate at which solution is pumped through the laminar flow tube.

49. The apparatus according to claim 41 wherein the laminar flow tube has an inner radius in a range from about 1 micrometer to about 1 cm.

50. The apparatus according to claim 41 wherein the laminar flow tube has a length in a range from about 1 mm to about 100 m.

51. A method for measuring the dissociation equilibrium constant K_{d} of a noncovalently bound complex TL involving a target T and a ligand L, defined by an equilibrium relationship
$$TL ⇄ T + L$$
and wherein the dissociation constant K_{d} is defined as
$${K}_{d} = \frac{[ T ] [ L ]}{[ TL ]}$$
where [T] is a concentration of the free (unbound) target T, [L] is a concentration of the free (unbound) ligand, and [TL] is a concentration of the noncovalently bound complex, the method comprising the steps of:
independently measuring an apparent diffusion coefficient of T, L and TL by
a) injecting an analyte solution containing a ligand L into a first end of a laminar flow tube of selected length and flowing the analyte solution to a second end of the laminar flow tube;
b) converting said analyte solution exiting said laminar flow tube at the second end thereof to a gaseous spray of ions and transferring the ions within said gaseous spray into a mass spectrometer;
c) developing a dispersion profile of the ligand L by monitoring signal intensities, measured by the mass spectrometer, of ions of the ligand as a function of time, and determining an apparent diffusion coefficient D_{L} of the ligand in the laminar flow tube from the signal intensity versus time dispersion profile;
d) repeating steps a), b) and c) for an analyte solution containing the target T itself to determine an apparent diffusion coefficient of the D_{T} of the target T;
e) repeating steps a), b) and c) for an analyte solution containing a known total concentration of ligand, [L]₀([L]₀=[L]+[TL]), and a known total concentration of target, [T]₀([T]₀32 [T]+[TL]), to give the noncovalently bound complex TL to determine an apparent diffusion coefficient Dₐₚₚ of the ligand L in the presence of the target T;
f) calculating a fraction f of free ligand L using an equation
$$f = \frac{{D}_{app} - {D}_{T}}{{D}_{L} - {D}_{T}} ; and$$
and
i) calculating K_{d} from the equation
$${K}_{d} = \frac{( {[ T ]}_{0} - {[ L ]}_{0} ( 1 - f ) ) \times ( {[ L ]}_{0} f )}{{[ L ]}_{0} ( 1 - f )}$$

52. A method for measuring the dissociation equilibrium constant K_{d} of a noncovalently bound complex TL involving a target T and a ligand L, defined by an equilibrium relationship
$$TL ⇄ T + L$$
and wherein the dissociation constant K_{d} is defined as
$${K}_{d} = \frac{[ T ] [ L ]}{[ TL ]}$$
where [T] is a concentration of the free (unbound) target T, [L] is a concentration of the free (unbound) ligand, and [TL] is a concentration of the noncovalently bound complex, the method comprising the steps of:
independently measuring diffusion profiles of T, L and TL by
a) injecting an analyte solution containing a ligand L into a first end of a laminar flow tube of selected length and flowing the analyte solution to a second end of the laminar flow tube;
b) converting said analyte solution exiting said laminar flow tube at the second end thereof to a gaseous spray of ions and transferring the ions within said gaseous spray into a mass spectrometer;
c) developing a dispersion profile of the ligand L by monitoring signal intensities, measured by the mass spectrometer, of ions of the ligand as a function of time;
d) repeating steps a), b) and c) for an analyte solution containing the target T itself to determine a dispersion profile of the target T;
e) repeating steps a), b) and c) for an analyte solution containing a known total concentration of ligand, [L]₀([L]₀=[L]+[TL]), and a known total concentration of target, [T]₀([T]₀=[T]+[TL]), to give the noncovalently bound complex TL to determine a dispersion profile of the ligand L in the presence of the target T;
f) expressing the dispersion profile (intensity vs. time, or I(t)) of the ligand in the presence of the target, Iₐₚₚ(t), as the weighted average of the dispersion profile of the free ligand, I_{L}(t), and that of the target, I_{T}(t), as described in Equation
Iₐₚₚ(t)=f×I_{L}(t)+(1−f)×I_{T}(t);
and
i) extracting the fraction of free ligand, f, from the Equation in step f) and calculating K_{d} from the equation
$${K}_{d} = \frac{( {[ T ]}_{0} - {[ L ]}_{0} ( 1 - f ) ) \times ( {[ L ]}_{0} f )}{{[ L ]}_{0} ( 1 - f )} .$$

53. The method according to claim 52 wherein the fraction of free ligand, f is extracted from the equation in step f) through the use of a non-linear least-square fitting algorithm.
